(19) United States
(12) Patent Application Publication
(10) Pub. No.: US 2023/0368227 A1
(43) Pub. Date: Nov. 16, 2023

(54) Automated Classification from Job Titles for Predictive Modeling

(71) Applicant: 6SENSE INSIGHTS, INC., San Francisco, CA (US)

(72) Inventors: Justin Chien, Saratoga, CA (US); Yulia Tyutina, Minneapolis, MN (US); Viral Bajaria, Redwood City, CA (US)

(21) Appl. No.: 18/196,130

(22) Filed: May 11, 2023

Related U.S. Application Data
(60) Provisional application No. 63/341,302, filed on May 12, 2022.

(51) Int. Cl. G06Q 30/0204; G06N 3/08

(52) U.S. Cl. CPC G06Q 30/0204; G06N 3/08

(57) ABSTRACT

The diversity of job titles prevents the extraction of information from job titles to be automated and scalable. Accordingly, disclosed embodiments utilize a machine-learning model to classify job titles by one or more characteristics, such as job level and/or job function. The characteristic(s) may be extracted from the job titles to be used as an input to a persona model that predicts a persona score, indicating the relative importance of a person to a sales opportunity.

### CROSS-REFERENCE TO RELATED APPLICATIONS

This application claims priority to U.S. Provisional Patent App. No. 63/341,302, filed on May 12, 2022, which is hereby incorporated herein by reference as if set forth in full.

### BACKGROUND

### Field of the Invention

The embodiments described herein are generally directed to predictive modeling, and, more particularly, to the automated classification of job level and job function from job titles for predictive modeling.

### Description of the Related Art

In business-to-business (B2B) marketing, personas can help a company organize its customers (e.g., existing and/or potential customers) into groups. In particular, personas that share one or more similar or identical characteristics can be grouped together. These groupings allow the company to analyze customer behavior and build marketing strategies, so that the company can methodically and deliberately target its sales efforts to each group. As an example, U.S. Patent Publication No. 2021/0406933 (“the '933 publication”), published on Dec. 30, 2021, which is hereby incorporated herein by reference as if set forth in full, describes one manner in which personas can be used for targeted marketing.

Any utilization of personas can benefit from an understanding of the job title of the person represented by the persona. This person may be an existing contact at an existing customer, an existing contact at a potential customer, a lead at an existing customer, a lead at a potential customer, or the like. In each case, the job title provides context about the person's level at the customer, as well as the person's function. Knowledge about job level and job function enables personas to be grouped into more granular target segments.

However, across all industries, job titles tend to be messy and unstandardized. Some may be short and/or formulaic, whereas others may be long and/or creative. This makes it impossible to automate and scale the determination of job level and job function from job titles. Traditionally, this task must be performed manually. The present disclosure is directed towards overcoming this and other problems discovered by the inventors.

### SUMMARY

Systems, methods, and non-transitory computer-readable media are disclosed to automate the classification of one or more characteristics, such as job level and/or job function, from job titles, for example, for persona-based predictive modeling.

In an embodiment, a method comprises using at least one hardware processor to, for each of one or more persons: receive a job title associated with the person; apply a machine-learning classification model to the job title to classify one or more characteristics of the job title, wherein the one or more characteristics comprise one or both of a job level or a job function; generate a persona comprising one or more attributes of the person, wherein the one or more attributes include the one or more characteristics; and apply a persona model to the one or more attributes to predict a persona score for the persona, wherein the persona score indicates a relative importance of the person to sales opportunities.

The machine-learning classification model may be an artificial neural network. The artificial neural network may be a deep-learning neural network. The deep-learning neural network may be a Recurrent Neural Network (RNN) with long short term memory (LSTM). Applying the machine-learning classification model to the job title may comprise embedding each word in the job title into an N-dimensional vector space.

The method may further comprise, before applying the machine-learning classification model to the job title, standardizing the job title. Standardizing the job title may comprise expanding contractions and abbreviations.

The method may further comprise, prior to applying the machine-learning classification model, training the machine-learning classification model using a training dataset in supervised learning, wherein the training dataset comprises job titles labeled with ground-truth classes.

The one or more characteristics may comprise the job level. The one or more characteristics may comprise the job function. The one or more characteristics may be a plurality of characteristics, including both the job level and the job function. The machine-learning classification model may comprise a first machine-learning classification model that classifies the job level from the job title, and a second machine-learning classification model that classifies the job function from the job title.

The method may further comprise storing the persona, in association with the persona score, in a master people database. The one or more characteristics may be a plurality of characteristics, including both the job level and the job function, and the method may further comprise generating a persona map, based on personas in the master people database, wherein the persona map comprises a first dimension representing a plurality of different job levels, and a second dimension representing a plurality of different job functions. The persona map may comprise a two-dimensional grid with a plurality of cells, wherein each of the plurality of cells represents a pairing of a job level in the first dimension with a job function in the second dimension. Each of the plurality of cells may indicate a number of personas, having the pairing of job level and job function represented by the cell, in each of one or more categories. Each of the plurality of cells may have a color in accordance with a color coding scheme, wherein the color coding scheme assigns a color within a color spectrum to each of the plurality of cells based on the persona scores associated with personas having the pairing of job level and job function represented by that cell.

The one or more persons may be a plurality of persons, and the method may further comprise using the at least one hardware processor to provide the personas, generated for the plurality of persons, to a recommendation engine that generates a list of recommended contacts based on the persona scores of the personas.

It should be understood that any of the features in the methods above may be implemented individually or with any subset of the other features in any combination. Thus, to the extent that the appended claims would suggest particular dependencies between features, disclosed embodiments are not limited to these particular dependencies. Rather, any of the features described herein may be combined with any other feature described herein, or implemented without any one or more other features described herein, in any combination of features whatsoever. In addition, any of the methods, described above and elsewhere herein, may be embodied, individually or in any combination, in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein, may be implemented, according to an embodiment;

FIG. 2 illustrates an example processing system, by which one or more of the processes described herein, may be executed, according to an embodiment;

FIG. 3 illustrates a process for training a machine-learning model for automatically classifying one or more characteristics from a job title, according to an embodiment;

FIG. 4 illustrates a process for operating a machine-learning model for automatically classifying one or more characteristics from a job title, according to an embodiment;

FIG. 5 illustrates a process for operating a machine-learning model to score personas, according to an embodiment;

FIG. 6 illustrates an example of a screen comprising a persona map, according to an embodiment;

FIG. 7 illustrates an example of a screen comprising various persona-based statistics, according to an embodiment; and

FIG. 8 illustrates an example of a screen comprising various statistics for a pairing of characteristics derived from job titles by a machine-learning model, according to an embodiment.

### DETAILED DESCRIPTION

In an embodiment, systems, methods, and non-transitory computer-readable media are disclosed for automated classification of one or more characteristics, such as job level and/or job function, from job titles, for example, for persona-based predictive modeling. After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

### 1. Example Infrastructure

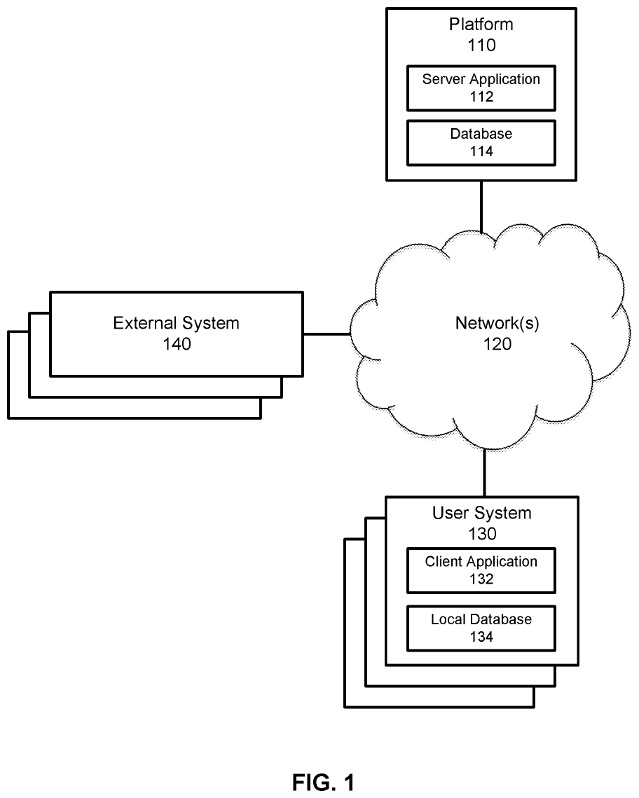

FIG. 1 illustrates an example infrastructure in which one or more of the disclosed processes may be implemented, according to an embodiment. The infrastructure may comprise a platform 110 (e.g., one or more servers) which hosts and/or executes one or more of the various processes, methods, functions, and/or software modules described herein. Platform 110 may comprise dedicated servers, or may instead be implemented in a computing cloud, in which the resources of one or more servers are dynamically and elastically allocated to multiple tenants based on demand. In either case, the servers may be collocated and/or geographically distributed. Platform 110 may execute a server application 112 and provide access to a database 114. In addition, platform 110 may be communicatively connected to one or more user systems 130 via one or more networks 120. Platform 110 may also be communicatively connected to one or more external systems 140 (e.g., other platforms, including third-party data sources, websites, etc.) via one or more networks 120.

Network(s) 120 may comprise the Internet, and platform 110 may communicate with user system(s) 130 and/or external system(s) 140 through the Internet using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to various systems through a single set of network(s) 120, it should be understood that platform 110 may be connected to the various systems via different sets of one or more networks. For example, platform 110 may be connected to a subset of user systems 130 and/or external systems 140 via the Internet, but may be connected to one or more other user systems 130 and/or external systems 140 via an intranet. Furthermore, while only a few user systems 130 and external systems 140, one server application 112, and one database 114 are illustrated, it should be understood that the infrastructure may comprise any number of user systems, external systems, server applications, and databases.

User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. However, it is generally contemplated that user system 130 will comprise the workstation or personal computing device of an agent (e.g., sales or marketing representative, data scientist, etc.) of a company or other organization in the B2B industry with an organizational account on platform 110, or an agent (e.g., programmer, developer, etc.) of the operator of platform 110. Each user system 130 may execute a client application 132 with access to a local database 134.

External system(s) 140 may also comprise any type or types of computing devices capable of wired and/or wireless communication, including those described above. However, it is generally contemplated that external system 140 will comprise a server-based system that hosts customer relationship management (CRM) software, marketing automation platform (MAP) software, a website, and/or the like, or the system of a third-party data vendor or other data source. External system 140 may send data to platform 110 (e.g., contacts or leads at existing or potential customers, website or other online activity, offline activity, marketing activity, etc.) and/or receive data from platform 110 (e.g., recommendations or other information about contacts or leads, new leads, etc.). In this case, external system 140 may “push” and/or “pull” data through an application programming interface (API) of platform 110, and/or platform 110 may “push” and/or “pull” data through an API of external system 140.

Platform 110 may comprise web servers which host one or more websites and/or web services. In embodiments in which a website is provided, the website may comprise a graphical user interface, including, for example, one or more screens (e.g., webpages) generated in HyperText Markup Language (HTML) or other language. Platform 110 may transmit or serve one or more screens of the graphical user interface in response to requests from user system(s) 130. In some embodiments, these screens may be served in the form of a wizard, in which case two or more screens may be served in a sequential manner, and one or more of the sequential screens may depend on an interaction of the user or user system 130 with one or more preceding screens. The requests to platform 110 and the responses from platform 110, including the screens of the graphical user interface, may both be communicated through network(s) 120, which may include the Internet, using standard communication protocols (e.g., HTTP, HTTPS, etc.). These screens (e.g., webpages) may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in database 114. It should be understood that platform 110 may also respond to other requests from user system(s) 130 that are unrelated to the graphical user interface.

Platform 110 may comprise, be communicatively coupled with, or otherwise have access to database 114. For example, platform 110 may comprise one or more database servers which manage database 114. Server application 112 executing on platform 110 and/or client application 132 executing on user system 130 may submit data (e.g., user data, form data, etc.) to be stored in database 114, and/or request access to data stored in database 114. Any suitable database may be utilized, including without limitation MySQL™, Oracle™ IBM™, Microsoft SQL™, Access™, PostgreSQL™, MongoDB™, and/or the like, including cloud-based databases and/or proprietary databases. Data may be sent to platform 110, for instance, using the well-known POST request supported by HTTP, via FTP, and/or the like. This data, as well as other requests, may be handled, for example, by server-side web technology, such as a servlet or other software module (e.g., comprised in server application 112), executed by platform 110.

In embodiments in which a web service is provided, platform 110 may receive requests from user system(s) 130 and/or external system(s) 140, and provide responses in eXtensible Markup Language (XML), JavaScript Object Notation (JSON), and/or any other suitable or desired format. In such embodiments, platform 110 may provide an API which defines the manner in which user system(s) 130 and/or external system(s) 140 may interact with the web service. Thus, user system(s) 130 and/or external system(s) 140 (which may themselves be servers), can define their own user interfaces, and rely on the web service to implement or otherwise provide the backend processes, methods, functionality, storage, and/or the like, described herein. For example, in such an embodiment, a client application 132, executing on one or more user systems 130, may interact with a server application 112 executing on platform 110 to execute one or more or a portion of one or more of the various functions, processes, methods, and/or software modules described herein.

Client application 132 may be “thin,” in which case processing is primarily carried out server-side by server application 112 on platform 110. A basic example of a thin client application 132 is a browser application, which simply requests, receives, and renders webpages at user system(s) 130, while server application 112 on platform 110 is responsible for generating the webpages and managing database functions. Alternatively, the client application may be “thick,” in which case processing is primarily carried out client-side by user system(s) 130. It should be understood that client application 132 may perform an amount of processing, relative to server application 112 on platform 110, at any point along this spectrum between “thin” and “thick,” depending on the design goals of the particular implementation. In any case, the software described herein, which may wholly reside on either platform 110 (e.g., in which case server application 112 performs all processing) or user system(s) 130 (e.g., in which case client application 132 performs all processing) or be distributed between platform 110 and user system(s) 130 (e.g., in which case server application 112 and client application 132 both perform processing), can comprise one or more executable software modules comprising instructions that implement one or more of the processes, methods, or functions described herein.

### 2. Example Processing System

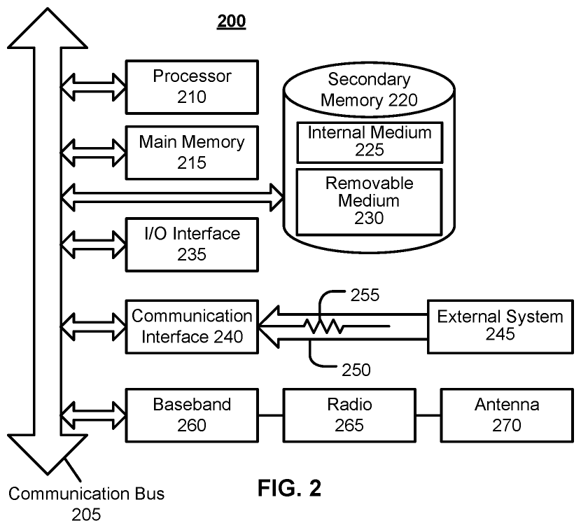

FIG. 2 is a block diagram illustrating an example wired or wireless processing system 200 that may be used in connection with various embodiments described herein. For example, system 200 may be used as or in conjunction with one or more of the processes, methods, or functions (e.g., to store and/or execute the software) described herein, and may represent components of platform 110, user system(s) 130, external system(s) 140, and/or other processing devices described herein. System 200 can be any processor-enabled device (e.g., server, personal computer, etc.) that is capable of wired or wireless data communication. Other processing systems and/or architectures may also be used, as will be clear to those skilled in the art.

System 200 may comprise one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a subordinate processor (e.g., back-end processor), an additional microprocessor or controller for dual or multiple processor systems, and/or a coprocessor. Such auxiliary processors may be discrete processors or may be integrated with a main processor 210. Examples of processors which may be used with system 200 include, without limitation, any of the processors (e.g., Pentium™, Core i7™, Core i9™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, and/or the like.

Processor(s) 210 may be connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 200 may comprise main memory 215. Main memory 215 provides storage of instructions and data for programs executing on processor 210, such as any of the software discussed herein. It should be understood that programs stored in the memory and executed by processor 210 may be written and/or compiled according to any suitable language, including without limitation C/C++, Java, JavaScript, Perl, Python, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

System 200 may comprise secondary memory 220. Secondary memory 220 is a non-transitory computer-readable medium having computer-executable code and/or other data (e.g., any of the software disclosed herein) stored thereon. In this description, the term “computer-readable medium” is used to refer to any non-transitory computer-readable storage media used to provide computer-executable code and/or supporting data to or within system 200. The computer software stored on secondary memory 220 is read into main memory 215 for execution by processor 210. Secondary memory 220 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 220 may include an internal medium 225 and/or a removable medium 230. Removable medium 230 is read from and/or written to in any well-known manner. Removable storage medium 230 may be, for example, a magnetic tape drive, a compact disc (CD) drive, a digital versatile disc (DVD) drive, other optical drive, a flash memory drive, and/or the like.

System 200 may comprise an input/output (I/O) interface 235. I/O interface 235 provides an interface between one or more components of system 200 and one or more input and/or output devices. Example input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing systems, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch panel display (e.g., in a smartphone, tablet computer, or other mobile device).

System 200 may comprise a communication interface 240. Communication interface 240 allows software to be transferred between system 200 and external devices (e.g. printers), networks, or other information sources. For example, computer-executable code and/or supporting data may be transferred to system 200 from a network server (e.g., platform 110) via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software transferred via communication interface 240 is generally in the form of electrical communication signals 255. These signals 255 may be provided to communication interface 240 via a communication channel 250 between communication interface 240 and an external system 245 (e.g., which may correspond to an external system 140, an external computer-readable medium, and/or the like). In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code is stored in main memory 215 and/or secondary memory 220. Computer-executable code can also be received from an external system 245 via communication interface 240 and stored in main memory 215 and/or secondary memory 220. Such computer-executable code, when executed, enable system 200 to perform the various functions of the disclosed embodiments as described elsewhere herein.

In an embodiment that is implemented using software, the software may be stored on a computer-readable medium and initially loaded into system 200 by way of removable medium 230, I/O interface 235, or communication interface 240. In such an embodiment, the software is loaded into system 200 in the form of electrical communication signals 255. The software, when executed by processor 210, preferably causes processor 210 to perform one or more of the processes and functions described elsewhere herein.

System 200 may comprise wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, then baseband system 260 decodes the signal and converts it to an analog signal. Then the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 is communicatively coupled with processor(s) 210, which have access to memory 215 and 220. Thus, software can be received from baseband processor 260 and stored in main memory 210 or in secondary memory 220, or executed upon receipt. Such software, when executed, can enable system 200 to perform the various functions of the disclosed embodiments.

Any of the described processes may be embodied in one or more software modules that are executed by processor(s) 210 of one or more processing systems 200, for example, as a service or other software application (e.g., server application 112, client application 132, and/or a distributed application comprising both server application 112 and client application 132), which may be executed wholly by processor(s) 210 of platform 110, wholly by processor(s) 210 of user system(s) 130, or may be distributed across platform 110 and user system(s) 130, such that some portions or modules of the software application are executed by platform 110 and other portions or modules of the software application are executed by user system(s) 130. The described processes may be implemented as instructions represented in source code, object code, and/or machine code. These instructions may be executed directly by hardware processor(s) 210, or alternatively, may be executed by a virtual machine operating between the object code and hardware processor(s) 210. In addition, the disclosed software may be built upon or interfaced with one or more existing systems.

Alternatively, the described processes may be implemented as a hardware component (e.g., general-purpose processor, integrated circuit (IC), application-specific integrated circuit (ASIC), digital signal processor (DSP), field-programmable gate array (FPGA) or other programmable logic device, discrete gate or transistor logic, etc.), combination of hardware components, or combination of hardware and software components. To clearly illustrate the interchangeability of hardware and software, various illustrative components are described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a component is for ease of description. Specific functions can be moved from one component to another component without departing from the disclosure.

Furthermore, while the processes, described herein, are illustrated with a certain arrangement and ordering of subprocesses, each process may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

### 3. Training

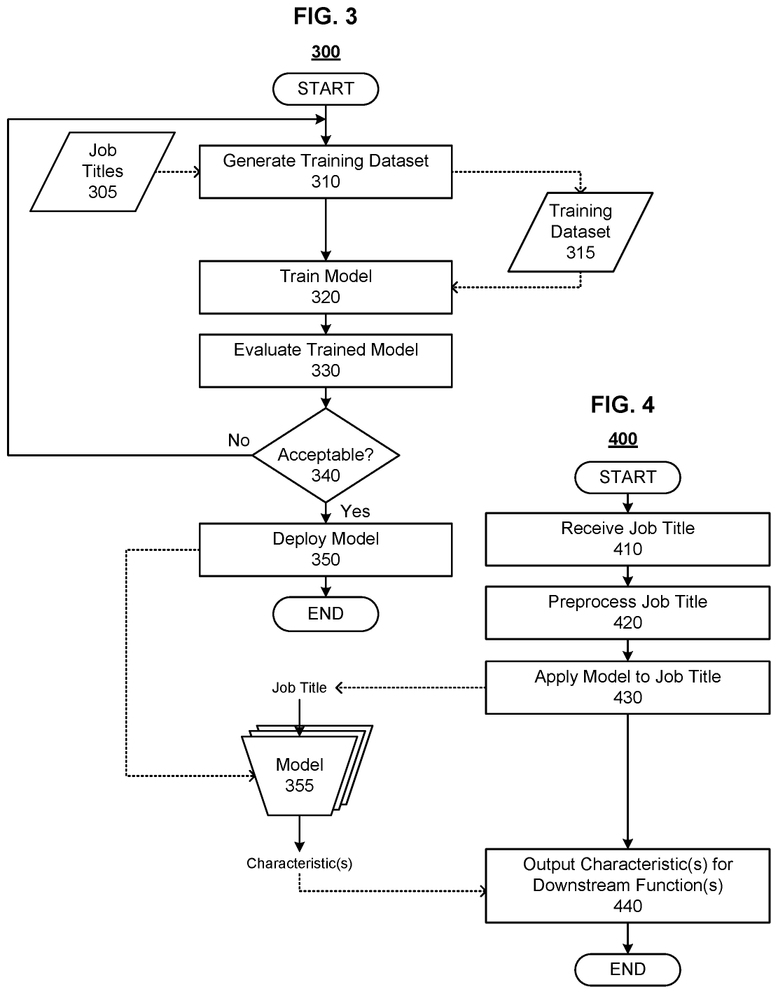

FIG. 3 illustrates a process 300 for training a machine-learning model for automatically classifying one or more characteristics from a job title, according to an embodiment. Process 300 may be performed under the direction of an agent (e.g., developer) of the operator of platform 110, to produce a machine-learning model that can be used to process job titles in an operational stage on platform 110.

The characteristics that are classified from job titles will primarily be exemplified herein as the job level and job function. However, it should be understood that different and/or additional characteristics (e.g., job responsibility) may be derived from the job title in a similar or identical manner, and that the number of distinct characteristics that are classified from each job title may consist of one, two, three, or more distinct characteristics. For example, the classified characteristic(s) could consist only of job level or only of job function, or may comprise one or more other characteristics in addition to or instead of job level and/or job function. Thus, any description herein that refers to job level and/or job function may be equally applied any one or more other characteristics (e.g., job responsibility).

The input to process 300 may be a job-title dataset 305 comprising or consisting of job titles. Job-title dataset 305 may be derived from a plurality of CRM systems for a plurality of customers, public datasets, a web crawler (e.g., that scrapes job titles from professional networking sites, such as Linkedln™), and/or the like. As used herein, the term “job title” refers to any string of one or more words, whether a name, phrase, sentence, sentence fragment, paragraph, narrative, or otherwise, that describes a person's job. Job titles tend to be very diverse, and will vary across different personalities, companies, industries, cultures, countries, and the like. For example, self-entered job titles may contain a large amount of prose and/or creative expression, in an effort to stand out from more mundane job titles.

In subprocess 310, a training dataset 315 is generated from job-title dataset 305. Prior to incorporation into training dataset 315, the job titles in job-title dataset 305 may be cleaned, standardized, or otherwise preprocessed. In particular, any word that is open to variation may be standardized to a single word. For example, contractions may be expanded (e.g., “I've” to “I have”), abbreviations and acronyms may be expanded (e.g., “VP”, “V P”, V.P.”, “Vice Pres.”, etc., may all be expanded to “vice president”), synonyms may be converted to a single standardized term (e.g., “CEO”, “chief executive officer”, “commander in chief”, “the boss”, “head honcho” may all be converted to “chief executive officer”), common or frequent typographical errors may be corrected, punctuation marks may be replaced with spaces or removed, and/or the like. Contractions, abbreviations, or other sources of variation that are ambiguous may be maintained as-is. In addition, stop words may be removed, since stop words do not add much information, but increase the complexity of classification. Stop words (e.g., “I”, “me”, “myself”, “we”, “our”, “ours”, “ourselves”, “you”, “you're”, etc.), which may be imported from the Python™ Natural Language Toolkit (NLTK), include articles, prepositions, pronouns, conjunctions, and the like. The preprocessing may be implemented as a user-defined function (e.g., in Java™), for example, in an Apache Hive™, that receives a raw job title as an input, performs the described preprocessing, and outputs a cleaned, standardized job title. As a result of the preprocessing, training dataset 315 will comprise a clean, standardized set of job titles that are consistent across all organizations. This consistency may improve the performance of the resulting machine-learning model.

In an embodiment, training dataset 315 comprises preprocessed job titles that are each labeled with at least one ground-truth characteristic. In a particular implementation, about one-hundred-thousand job titles were manually labeled with a ground-truth job level and a ground-truth job function. When all job titles were pooled together across all data sources and sorted by frequency, the data had a long tail. This long tail was primarily the result of manually entered titles, which were subject to typographical errors, creative interpretations, foreign languages, and the like. Out of 32.3 million unique job titles, the most frequently occurring job title was “owner” with a frequency of 4.4 million, compared to 18.2 million job titles that only appeared once. From this dataset, the one-hundred-thousand most frequent job titles were included in training dataset 315, which covered 80% of all of the job titles, with a lowest frequency of one-hundred-twenty occurrences.

Each job-title in training dataset 315 was labeled with a target value for job level, representing the ground-truth job level, and a target value for job function, representing the ground-truth job function. Each target value for each characteristic was a class selected from a finite plurality of classes available for that characteristic. The finite plurality of classes for a characteristic may include one or more exception-handling classes for job titles that do not fit any of the other plurality of classes and/or for job titles that contain a foreign language. For instance, in a particular implementation, the plurality of classes for job level consisted of: staff; senior; manager; director; vice president; c-level; other; and foreign language. In this particular implementation, the plurality of classes for job function consisted of: accounting; administrative; arts and design; business and development; consulting; education; engineering; finance; healthcare services; human resources; information technology; legal; marketing; media and communications; military and protective services; operations; product management; purchasing; quality assurance; real estate; sales; customer service and support; management; do not contact; other; and foreign language. It should be understood that these are simply non-limiting examples, and that the plurality of classes for job level and/or job function may be defined to include fewer, more, or different classes. It should also be understood that alternative characteristics may be defined in a similar manner.

In subprocess 320, a model is trained using training dataset 315. In particular, the model may be trained from the preprocessed job titles, labeled with ground-truth classifications, in training dataset 315, using supervised learning. In an embodiment, a separate model is trained for each characteristic that is to be classified. For example, a first model may be trained using the ground-truth classifications for job level, and a second model may be trained using the ground-truth classifications for job function. It should be understood that the job titles may be the same in each training, and that only the target values will differ. Alternatively, a single model may be trained to classify a job title with two or more characteristics, such as both job level and job function.

In subprocess 330, each model, trained in subprocess 320, may be evaluated. The evaluation may comprise validating and/or testing the model using a portion of training dataset 315 that was not used to train the model in subprocess 320. The result of subprocess 330 may be a performance measure for the model, such as an accuracy of the model. The evaluation in subprocess 330 may be performed in any suitable manner.

In subprocess 340, it is determined whether or not the model, trained in subprocess 320, is acceptable based on the evaluation performed in subprocess 330. For example, the performance measure from subprocess 340 may be compared to a threshold or one or more other criteria. If the performance measure satisfies the criteria (e.g., is greater than or equal to the threshold), the model may be determined to be acceptable (i.e., “Yes” in subprocess 340). Conversely, if the performance measure does not satisfy the criteria (e.g., is less than the threshold), the model may be determined to be unacceptable (i.e., “No” in subprocess 340). When the model is determined to be acceptable (i.e., “Yes” in subprocess 340), process 300 may proceed to subprocess 350. Otherwise, when the model is determined to be unacceptable (i.e., “No” in subprocess 340), process 300 may return to subprocess 310 to retrain the model (e.g., using a new training dataset 315, different hyperparameters, etc.).

In subprocess 350, the trained and accepted model may be deployed as a model 355. It should be understood that in an embodiment in which a separate model is trained for each of two or more characteristics, process 300 may be executed for each characteristic (e.g., using the same training dataset 315 with different ground-truth labels) to produce a separate model 355 for each characteristic. In this case, there will be a plurality of models 355 (i.e., one model 355 for each characteristic that is to be classified). In any case, each model 355 receives a job title as an input, and outputs the class of one or more characteristics (e.g., job level and/or job function) of that job title. Each model 355 may be deployed by moving the model 355 from a development environment to a production environment. For example, the model 355 may be made available at an address on platform 110 (e.g., in a microservice architecture) that is accessible to a predictive model or other service or application that utilizes the model 355.

To increase the inference speed of each model 355, the model 355 may be exported from the format in which it was developed (e.g., Pytorch™) into the Open Neural Network Exchange (ONNX) format. The ONNX format is an open format that enables the model 355 to be moved between various machine-learning frameworks and tools. Additionally or alternatively, the weights of each model 355 may be quantized into 8-bit integer values, instead of 32-bit floating-point values. Quantization of the weights increases the inference speed of the model 355, with equivalent results and similar performance. The files, representing the model 355, may be built into the Python™ Executable (PEX) format, such that they are self-contained executable Python™ virtual environments, and incorporated into a user-defined function in Apache Hive™ Apache Hive™ is a data warehouse software project, built on Apache Hadoop™, for providing data query and analysis.

Process 300 may be performed periodically for each model 355 to retrain the model 355 based on a new job-titles dataset 305 (e.g., comprising new job titles collected since the last iteration of process 300), feedback from users, updates to the finite plurality of classes used for the characteristic(s) being modeled by the model 355, and/or the like. In this case, a new model 355 may be deployed in subprocess 350 with a new version number. The old model 355 (i.e., deployed in a previous iteration of process 300) may be maintained with an older version number, such that it may still be applied when appropriate.

### 4. Operation

FIG. 4 illustrates a process 400 for operating one or more machine-learning model(s) 355 for automatically classifying one or more characteristics from a job title, according to an embodiment. Process 400 may be executed as a subroutine within a larger software service or application. Alternatively, process 400 may be executed as its own service (e.g., in a microservice architecture), which is accessible at a particular address to other services or applications. In either case, the input to process 400 may be a job title, and the output of process 400, may be the class of each characteristic from the job title that has been modeled (e.g., job level and/or job function).

Initially, in subprocess 410, at least one job title may be received. Each job title may be represented as a string or other data type. In an embodiment, the job title(s) may be passed as an input parameter by a caller of process 400. The job title(s) may be received as individual inputs to process 400, or a plurality of job titles may be processed by process 400 as a batch.

In subprocess 420, the job title(s), received in subprocess 410, may be preprocessed. Preprocessing may comprise cleaning and/or standardizing each job title in the same manner as the job titles were preprocessed in subprocess 310 to produce training dataset 315. In particular, any word that is open to variation may be standardized to a single word. For example, contractions may be expanded, abbreviations and acronyms may be expanded, synonyms may be converted to a single standardized term, common or frequent typographical errors may be corrected, punctuation marks may be replaced with spaces or removed, and/or the like. Contractions, abbreviations, or other sources of variation that are ambiguous may be maintained as-is. Thus, each job title that is input to model(s) 355 during operation will be consistent with the job titles that were used to train model(s) 355.

In subprocess 430, each model 355, which was trained in subprocess 320 of process 300 and deployed by subprocess 350 of process 300, may be applied to the preprocessed job title(s), output by subprocess 420. In particular, each job title is input into each model 355. Each model 355 may be applied to individual job titles or, when there are a plurality of job titles to be processed, batches of job titles, for faster processing.

In an embodiment, each model 355 identifies the class of the modeled characteristic from the job title. In a particular embodiment, one or more models 355 infer both the class of job level and the class of job function from each job title. Each inference may be performed by a separate model 355. Collectively, model(s) 355 output the inferred class(es), which may comprise a class of job level and/or a class of job function. If a model 355 is trained to identify the class of one or more other characteristics from job titles (e.g., job responsibility), any of those other classes will also be output in subprocess 430.

In subprocess 440, the output of model(s) 355, which includes a class of each characteristic (e.g., job level and/or job function) from each job title, may be output. For example, the output may be returned as a response to the caller of process 400. This output may be used by the caller for one or more downstream functions, such as predictive modeling, as discussed elsewhere herein. Each class may be represented as an enumeration, string, or other data type.

### 5. Model

In an embodiment, subprocess 430 may comprise transforming each job title into another format before applying model 355 to the job title. It should be understood that, in such an embodiment, the same transformation will be applied to the job titles in training dataset 315, either when generating training dataset 315 in subprocess 310 or when training the model in subprocess 320. In an embodiment, each job title is transformed into an embedding within an N-dimensional space.

The transformation may comprise the Word2Vec algorithm by Google of Mountain View, California. The Word2Vec algorithm uses a neural network to learn word associations from a corpus of text (e.g., 100 billion words from various news articles). Word2vec represents each distinct word with a vector of numbers, such that a mathematical function (e.g., cosine similarity) can be applied to two vectors to indicate the level of semantic similarity between the two words represented by those two vectors. In particular, word2vec uses a group of shallow, two-layer neural networks that are trained using a training dataset to reconstruct linguistic contexts of words using a vector space that is typically hundreds of dimensions (e.g., 300 dimensions). Each word in the training dataset is assigned a corresponding vector in the vector space (e.g., a 300-dimensional vector in a 300-dimensional space), such that words that share common contexts in the training dataset are located close to each other in the vector space. Implementations of Word2Vec algorithm exist in machine-learning libraries in Python™, including the Gensim library and H2O. While this implementation of the Word2Vec algorithm is only trained on words in the English language, it should be understood that separate Word2Vec algorithms could be trained on other languages, and used to create embeddings for job titles in other languages. The Word2Vec algorithm could also be fine-tuned for job titles.

Although the transformation will be primarily described herein as the Word2Vec algorithm, it should be understood that other transformations may be used, including other embeddings. The transformation may create embeddings for only words in a single language (e.g., English) or for words spanning a plurality of different languages.

In general, the transformation (e.g., Word2Vec algorithm) may be applied to each word in each job title, which may be preprocessed in subprocess 420, to create an N-dimensional embedding vector in the N-dimensional vector space for each word in the job title. However, since only a relatively small subset of words is utilized in job titles, in an embodiment, a look-up dictionary is generated for the subset of the words that regularly occur in job titles. For example, during training process 300, the transformation may be applied to every word across all job titles in training dataset 315 (e.g., in subprocess 310, after the preprocessing) to generate the embedding vector for each of these words. The words and their corresponding embedding vectors may then be associated with each other to generate the look-up dictionary. In particular, each embedding vector may be indexed (e.g., in a table of a relational database) by the corresponding word in its preprocessed form, such that the embedding vector can be quickly retrieved for each word in the job titles in training dataset 315.

It should be understood that this look-up dictionary may be generated after process 300, and may be updated after each iteration of process 300 (i.e., whenever a model 355 is retrained). The same look-up dictionary may be used for all models 355, since the word embeddings will not differ between models 355.

In subprocess 430, each word in each job title may be firstly looked up in the look-up dictionary. If the look-up dictionary returns an embedding vector for a word, that embedding vector is used for that word. On the other hand, if the look-up dictionary does not return an embedding vector for a word, this means that the word is not in the look-up dictionary, and thus, the Word2Vec algorithm may be applied to the word to obtain the embedding vector. In this case, the word and its corresponding embedding vector may also be added to the look-up dictionary for future look-ups. Advantageously, the look-up dictionary provides a quick mechanism to generate the embedding vectors for the most common words found in job titles. Since the look-up dictionary only includes words that are in the subset of the language(s) used to write job titles, the use of the look-up dictionary significantly increases the speed of the transformation of words into embeddings.

The output of the transformation for a given job title is a vector comprising an embedding vector for each word in that job title. While most job titles are four to five words, more descriptive job titles can be much longer. Thus, in an embodiment, the length of the job titles is limited to a maximum number of words (e.g., thirty-two words). For job titles that have fewer than the maximum number of words, the vector may be padded with zero-valued embedding vectors. The vectors may be left-justified for each job title (i.e., vectors are padded on the right side) to establish positional consistency within the job levels. For example, if “senior” is present in a job title, it will typically be the first word.

The vectors may also be encoded by one or more pre-trained language models, such as one or more transformers. This enables words that have not been previously seen by a model to be represented as an embedding vector within the context of the other words that were seen during training of the model. Examples of these pre-trained language models include, without limitation, the Universal Sentence Encoder (USE), the Bidirectional Encoder Representations from Transformers (BERT) and/or any of the variations of BERT, Embeddings from Language Models (ELMo), the fastText model, any version of the Generative Pre-trained Transformer (GPT), and the like.

In an embodiment, each model 355 may comprise an artificial neural network. In a particular embodiment, the artificial neural network is a deep-learning network. For example, model 355 may be a recurrent neural network (RNN) with long short-term memory (LSTM). This type of artificial neural network is well-suited for language processing. Firstly, with LSTM, the location of a word in a sequence matters. For instance, a “senior developer” is different than a “developing senior.” Secondly, sometimes a job title is a paragraph describing a person's job. The LSTM can decipher sequences of words to understand sentences. Thirdly, the same word can be used differently in the everyday context than in the context of a job title. For instance, “software engineer” is the same as “code monkey” and “code ninja,” but is different than “mechanical engineer,” “monkey trainer,” and “ninja assassin.” With an LSTM, the true meaning of a word can be associated with the correct context.

The tables below describe the structure of a first model 355 for classifying the job level from a job title into one of eight possible classes, and a second model 355 for classifying the job function from a job title into one of twenty-six possible classes. Both models used a similar structure. In each model, the first layer is the embedding layer which produces an embedding vector for each word in a job title (e.g., using the Word2Vec algorithm or other transformation), the second layer is a single LSTM layer, and the third layer is a softmax prediction dense layer, compiled using categorical cross-entropy loss and the Adam optimizer. To prevent overfitting, during training, a first 20% dropout layer may be added between the embedding layer and the LSTM layer, and a second 20% dropout layer may be added between the LSTM layer and the softmax prediction dense layer. The largest difference between the first model and the second model is that the softmax prediction in the first model for classifying job level has eight classes, whereas the softmax prediction in the second model for classifying job function has twenty-six classes. It should be understood that either model may classify into fewer, more, or different classes, and models for other characteristics may be built using a similar structure.

Model Structure for Classifying Job Level

| Layer | Output Shape | No. of Parameters |
|---|---|---|
| Embedding | (None, 32, 300) | 1,145,100 |
| Dropout | (None, 32, 300) | 0 |
| LSTM | (None, 300) | 721,200 |
| Dropout | (None, 300) | 0 |
| Dense | (None, 8) | 2,408 |

Total No. of Parameters: 1,868,708
Trainable Parameters: 723,608
Non-Trainable Parameters: 1,145,100

Model Structure for Classifying Job Function

| Layer | Output Shape | No. of Parameters |
|---|---|---|
| Embedding | (None, 32, 300) | 1,145,100 |
| Dropout | (None, 32, 300) | 0 |
| LSTM | (None, 300) | 721,200 |
| Dropout | (None, 300) | 0 |
| Dense | (None, 26) | 7,826 |

Total No. of Parameters: 1,874,126
Trainable Parameters: 729,026
Non-Trainable Parameters: 1,145,100

In a particular implementation, the weights of each model 355 were exported as a Hierarchical Data Format 5 (H5) file, and loaded into Eclipse Deeplearning4j (DL4J), which is an open-source, distributed, deep-learning framework for the Java Virtual Machine. Using DL4J, each model 355 can be implemented as a user-defined function in Apache Hive. The user-defined function for each model 355 can be chained together after the call to the user-defined function for preprocessing job titles, such that extracting the respective job level and job function for a given job title becomes as easy as a SELECT statement in a Structured Query Language (SQL) Hive query. This saves time and eliminates the need for intermediate steps whenever utilizing model 355 for predictions, while passing information between tables (e.g., in database 114).

Some transformer language models, such as BERT, do not need to utilize a separately trained neural network. In this case, the input job title may be processed and given an overall representation based on the pre-trained large language model (e.g., an open-source model). A classifier may then be layered on top of the language model to assign the input job title to a predefined class based on the aforementioned training dataset. This is also known as “fine-tuning” the language model.

In an embodiment in which platform 110 processes millions of job titles per day, over many iterations of process 400, a significant amount of resources may be required. Accordingly, in an embodiment, to decrease the required amount of resources, a cache was introduced to save the job levels and job functions for previously classified job titles. The cache may be indexed by the preprocessed version of the job title. Thus, when the same job title is seen again, the associated job level and job function can be retrieved from the cache, such that model 355 does not have to be reapplied to the cached job title. The cache may be purged each time model 355 is retrained (e.g., by another iteration of process 300).

Model 355 for each characteristic may output a probability vector, representing the probability of each of the plurality of possible classes for the characteristic. Using the above example, the first model 355 for classifying job level may output a probability vector with eight probability values, and the second model 355 for classifying job function may output a probability vector with twenty-six probability values. The sum of the probability values in each probability vector may sum to one. In an embodiment, the single class with the highest probability value may be returned. Alternatively, the probability vector may be returned.

As another alternative, for each characteristic, any one or more classes with a probability value that is higher than a threshold value may be returned, or classes with the N highest probability values may be returned. This alternative may be especially appropriate for characteristics, such as job function, for which a job title may convey multiple different classes (i.e., a job title may convey multiple different job functions). In this case, all of the classes that are returned for a given characteristic may be used for the downstream function(s) (e.g., incorporated as attributes into the persona associated with the job title).

In an embodiment in which a single class with the highest probability value is returned, the user-defined function for each model 355 may return an enumeration value or human-readable value for the class of the characteristic being predicted, depending on a parameter (e.g., Boolean value) included in the call to the user-defined function. The enumeration value may be a numeric value within a range equal to the number of possible classes for the characteristic, whereas the human-readable value may be a string comprising or consisting of the English-language name of the class. The enumeration value may be used for easier machine interpretability if the class is to be used in an automated downstream function (e.g., an input to another machine-learning model), whereas the human-readable value may be used in a graphical user interface for better human interpretability.

The following represents the form of chained user-defined functions in a Hive environment, which may be used to extract job level and job function from raw job titles in an embodiment of subprocesses 420 and 430:
extract_job_level(clean_job_title(raw_job_title), version, human_readable);
extract_job_function(clean_job_title(raw_job_title), version, human_readable);
   wherein raw_job_title is the raw_job_title being processed, version is the version number of the respective model 355 that should be used to extract the characteristic class, human_readable is a Boolean value that is true if the returned characteristic class should be human_readable (e.g., a string) and false if the returned characteristic class should not be human_readable (e.g., an enumeration value), clean_job_title ( ) is an implementation of subprocess 420, extract_job_level( ) is an implementation of subprocess 430 for job level, and extract_job_function( ) is an implementation of subprocess 430 for job function.

The following represent examples of actual calls to the chained user-defined functions in a Hive environment:

> SELECT extract_job_level(clean_job_title(′CEO′), ′v1.1.1′, ′true′);
OK
c-level
> SELECT extract_job_function(clean_job_title(′CEO′), ′v1.1.1′, ′true′);
OK
management
> SELECT extract_job_function(clean_job_title(′CEO′), ′v1.1.1′, ′false);
OK
23

### 6. Example Applications

In an embodiment, process 400, which applies model 355, is used in a larger software application, which may be implemented as a service. For example, process 400 may classify the job level, job function, and/or other characteristics from job titles, to provide context to or otherwise inform customer personas for various B2B goals. These customer personas may be generated by a downstream function that uses the extracted classifications.

It should be understood that a downstream function may generate the customer personas based on other information, in addition to the classified characteristics (e.g., job level and/or job function), and potentially including other information extracted from the job titles. The combined information may expand the understanding of customer personas and/or enable new customer personas to be captured.

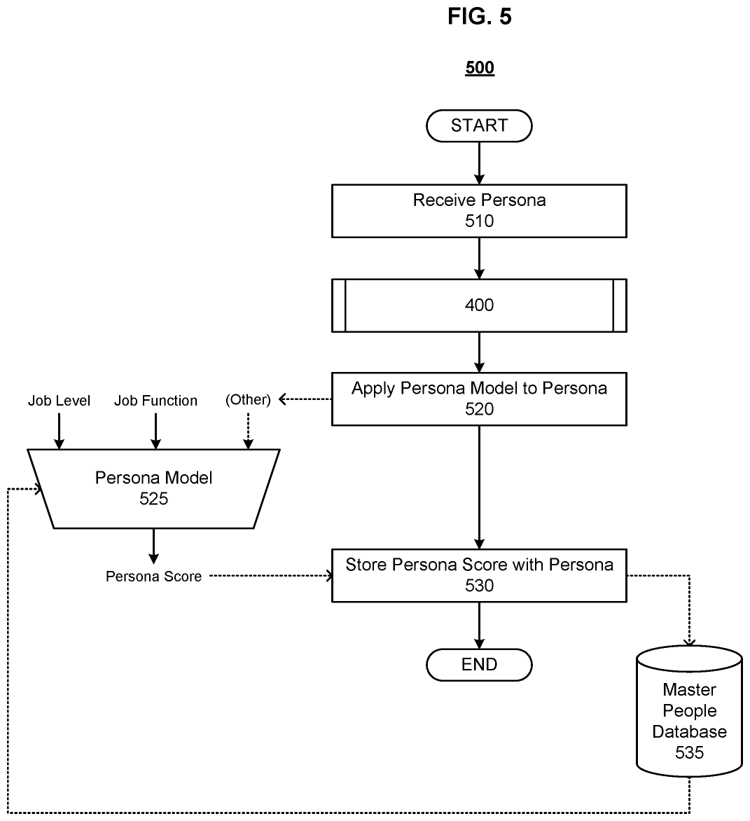

FIG. 5 illustrates a process 500 for operating a machine-learning model to score personas, according to an embodiment. Process 500 may be executed as a subroutine within a larger software application. Alternatively, process 500 may be executed as its own software application (e.g., as a service in a microservice architecture), which is accessible at a particular address to other applications (e.g., other services). In either case, the input to process 500 may be a persona, and the output of process 500, may be a persona score. It should be understood that process 500 represents an example of one downstream function which may utilize process 400.

Initially, in subprocess 510, at least one persona may be received. The persona(s) may be received as individual inputs to process 500, or a plurality of personas may be processed by process 500 as a batch. Each persona may represent a person, and be represented in a data structure storing one or more attributes of the person. At least one of the attributes may be a job title associated with the person. The persona may also include other attributes, such as a name (e.g., first and last name), contact information (e.g., email address, telephone number, etc.), the company for which the person works (e.g., a company name or other company identifier), the location (e.g., company site) at which the person works (e.g., address, city, state, Zip code, etc.), activity information (e.g., website visits or other online activity, offline activity, etc.) associated with the person, if any, and/or the like. The persona(s) may be received from an internal data source (e.g., database 114) or from an external system 140.

Next, process 400 may be performed, as a subprocess of process 500. In particular, model 355 may be applied to the job title(s) from the persona(s), received in subprocess 510, to extract one or more characteristics (e.g., job level and/or job function) from each job title. Any resulting characteristics, extracted from the job title from a persona, may be added as attribute(s) to that persona.

In subprocess 520, persona model 525 may be applied to the persona(s), which include the extracted characteristics (e.g., job level and/or job function), derived in process 400, as attributes. In particular, one or more attributes of each persona is input into model 525. In an embodiment, these attributes include at least the job level and job function, and may include one or more other attributes as well. Persona model 525 may be applied to individual personas or, when there are a plurality of personas to be processed, batches of personas, for faster processing.

In an embodiment, persona model 525 is a predictive model that predicts a persona score from the attributes of each persona that were input to persona model 525. Persona model 525 may be the same as or similar to the persona model described in the '933 publication. For example, persona model 525 may receive an input comprising or consisting of the job level and/or job function for a given job title for a person, output by model 355, and output a persona score for the person. The persona score may indicate the person's relevance or importance to sales opportunities or influence over sales opportunities. The persona score may be a number within a range (e.g., 0 to 100), in which one end (e.g., 0) of the range represents no fit and the opposite end (e.g., 100) of the range represents a perfect fit.

Persona model 525 may be trained as described in the '933 publication or in any other suitable manner to predict a persona score for a particular set of persona attributes. For example, personal model 525 may be a machine-learning model that is trained, using supervised learning, on a training dataset comprising sets of persona attributes as features, with each set of features labeled with a persona score as the target value for that set of features.

In subprocess 530, the output of persona model 525, which may comprise or consist of the persona score for each persona received in subprocess 510, may be stored, in association with the respective persona(s), in master people database 535. Master people database 535 may comprise a plurality of personas, scored by process 500, for use in one or more downstream functions. In addition, if personal model 525 is implemented as a statistical model, persona model 525 may utilize data from master people database 535 to calculate the persona scores in subprocess 520.

One example of a downstream function in which scored personas may be used is a persona map. In an embodiment, software (e.g., server application 112 and/or client application 132) is configured to generate a persona map, representing one or more customers of an organization that has an organizational account with platform 110. The persona map may indicate the relative importance or strength of contacts with each characteristics (e.g., job level and job function), along with the status of engagements with contacts having each characteristic. The relative strength of a contact may be determined based on the persona score associated with that contact, and may be depicted using a color coding and/or in any other suitable manner.

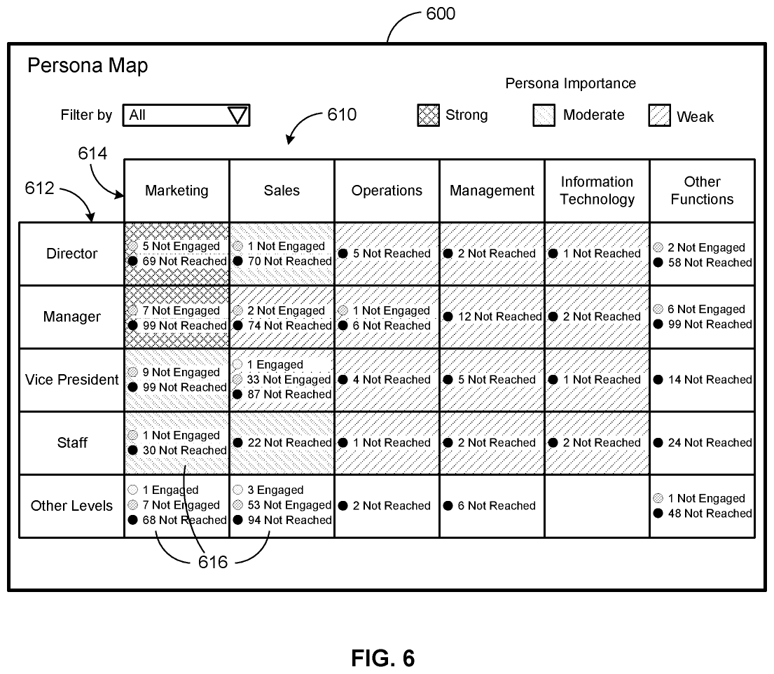

FIG. 6 illustrates an example of a screen 600 comprising a persona map 610, according to an embodiment. Screen 600 may be one screen among a plurality of screens in an overarching graphical user interface that is accessible to the user of a user account with platform 110. Screen 600 may be accessible, within the graphical user interface, via standard navigation through a set of one or more hierarchical menus available to the user (e.g., starting from a dashboard of the user account). Screen 600 may comprise standard components, such as a filter for filtering the data in persona map 610, according to one or more criteria, and a legend that defines the color coding in persona map 610.

Persona map 610 may comprise a two-dimensional grid. A first dimension 612 may represent a first characteristic, such as job level, and a second dimension 614 may represent a second characteristic, such as job function. First dimension 612 is illustrated as the horizontal dimension (i.e., rows), whereas second dimension 614 is illustrated as the vertical dimension (i.e., columns). However, it should be understood that these dimensions could easily be reversed, such that first dimension 612 is the vertical dimension, and second dimension 614 is the horizontal dimension. In an embodiment, job levels and/or job functions, for which there are few associated personas and/or which are associated with very low persona scores (e.g., below a predefined threshold), may be grouped together into an “other” row and/or column, respectively.

Each cell 616 in persona map 610 represents a pairing of a first characteristic of first dimension 612 with a second characteristic of second dimension 614. In the illustrated embodiment, each cell 616 represents a pairing of a job level with a job function. For example, a cell 616 in the row for “Manager” and in the column for “Sales” represents all personas that are sales managers. Similarly, a cell 616 in the row for “Vice President” and in the column for “Information Technology” represents all personas that are vice presidents of information technology. Each pairing of job level and job function may be associated with any number of personas, including, zero, one, or any plurality of personas.

Which personas are included in persona map 610 may depend on how the data is filtered. For example, the user may select no filter, in which case persona map 610 may comprise data for all personas of all customers of the organization. Alternatively, the user may select a filter for a specific market segment, in which case, persona map 610 will only comprise data for all personas of all customers of the organization in the selected market segment. It should be understood that any number of other filters may be provided in the same manner.

Each cell 616 may provide a number or count of personas, having the pairing of the first characteristic (e.g., job level) and second characteristic (e.g., job function) represented by that cell 616, in each of one or more categories. For example, the categories may include personas that have been engaged (e.g., an agent of the organization is in active communication with the person associated with the persona), personas that have not been engaged (i.e., no agent of the organization has made any attempt to communicate with the person associated with the persona), and/or personas that have been reached (e.g., an agent of the organization has reached out to the person associated with the persona, but is not in active communication with that person). It should be understood that these are simply examples of the categories, and that fewer, more, or different categories may be used. Each category in each cell 616 may be selectable (e.g., implemented as a hyperlink), such that a user may select a category for a particular pairing of job level and job function in the cell 616 to see additional details (e.g., on a further screen of the graphical user interface, or in a frame of the same screen 600).

In addition, each cell 616 may be color coded according to the relative strength of the personas having the pairing of job level and job function represented by that cell 616. Again, relative strength may be determined by the relative persona score, with higher persona scores indicating a stronger persona, and lower persona scores indicating a weaker persona. It should be understood that a stronger persona is one with which engagement is more likely to result in a positive outcome to a sales opportunity (e.g., a higher win rate, creation rate, or other conversion rate), according to persona model 525. Conversely, a weaker persona is one with which engagement is less likely to result in a positive outcome to a sales opportunity (e.g., a lower win rate, creation rate, or other conversion rate), according to persona model 525. In other words, the contacts associated with stronger personas are more important to making a sale than contacts associated with weaker personas. Thus, in general, more effort should be directed towards engaging contacts with stronger personas.

In an embodiment, each cell 616 may have a background color in accordance with a color coding scheme, which assigns a color within a color spectrum (e.g., having a plurality of discrete colors or a range of colors) to each cell 616, based on the persona scores associated with personas having the pairing of characteristics (e.g., job level and job function) represented by that cell 616. For example, cells 616 representing pairings of job level and job function, associated with stronger personas, may be colored with bolder background colors (e.g., darker blues), and cells 616 associated with pairings of job level and job function, associated with weaker personas, may be colored with weaker background colors (e.g., lighter blues). Cells 616 associated with pairings of job level and job function, associated with moderate personas, may be colored with moderate background colors (e.g., one or more moderate shades of blue). While only three levels of persona strength (i.e., strong, moderate, and weak) are illustrated in persona map 610, it should be understood that any number of different levels of persona strength may be depicted in persona map 610. The persona strength for a given persona may be determined based on a weighted average of three parameters: the average persona score for all persons with that persona; the fraction of the master people database 535 that the persona represents (e.g., if there are 1,000 people and 100 are marketing directors, the fraction value for personas that are marketing directors would be 0.1); and the fraction of instances in which the persona was contacted prior to a won opportunity (e.g., calculated from CRM task activities).

A user may utilize persona map 610 to analyze the behavioral patterns and opportunity data of personas in the past, as well as the characteristics (e.g., job level and/or job function) of the personas that have been engaged or contacted. This may enable the user to uncover the best new contacts and leads to which to reach out or with which to otherwise engage. In addition, the user can quickly identify the types of personas that have been contacted, whether these personas are engaged, whether unengaged personas should be contacted, the types of personas that exist at customers, the level of influence that certain types of personas have on sales opportunities, and/or the like. By understanding the best-fit personas (e.g., via the color coding scheme of persona map 610), the user may select the various categories of personas in one or more cells 616 to more deeply analyze the specific contacts associated with the various personas. Based on this analysis, the user can narrow the focus of marketing or other activities towards those contacts with the highest likelihood of being able to influence a sales opportunity (i.e., move the opportunity closer to a completed sale). For example, marketing efforts may be focused on the strongest personas whom have not yet been engaged or contacted. This can help drive a sales opportunity forward.

In an embodiment, the user may customize dimensions 612 and/or 614 to include a specific grouping of job levels and/or job functions as a column or row. For example, the user could group a set of job levels, output by model 355, into a single group to be represented as a single row in dimension 612. Similarly, the user could group a set of job functions, output by model 355, into a single group to be represented as a single column in dimension 614. Thus, a user can build customizable job levels and/or job functions, as groups of more granular job levels and/or job functions output by model 355, to be visualized in persona map 610.

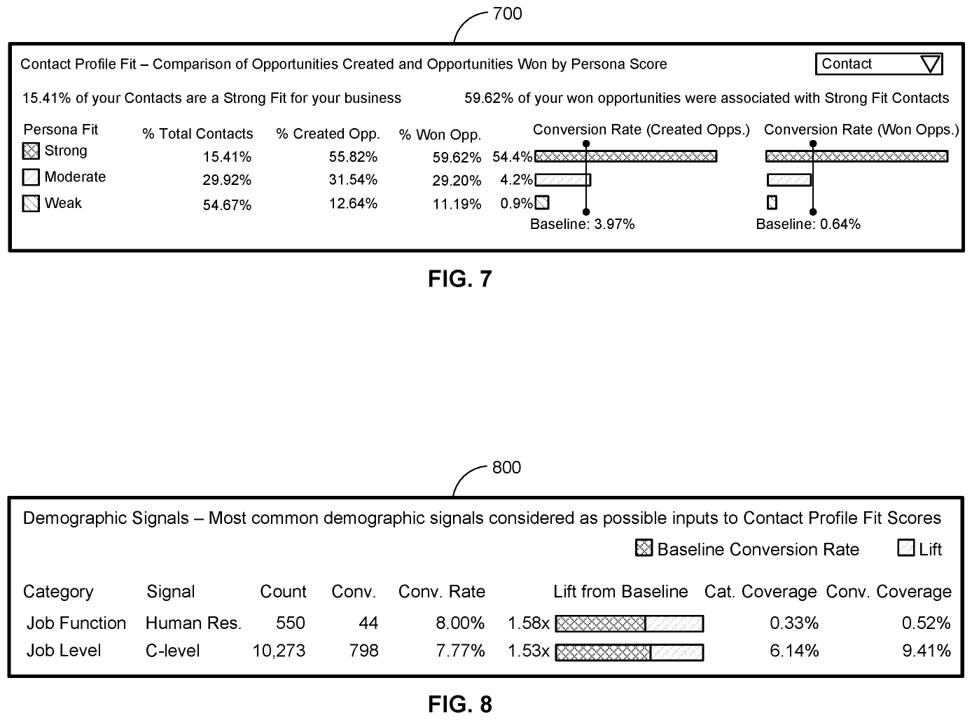

Other statistics may be derived from the persona scores and/or characteristics output by model 355 (e.g., job level and/or job function). For example, FIGS. 7 and 8 illustrate examples of screens 700 and 800, respectively, providing various statistics, according to embodiments. Each of screens 700 and/or 800 may be a screen among a plurality of screens in an overarching graphical user interface that is accessible to the user of a user account with platform 110. Screens 700 and/or 800 may be accessible, within the graphical user interface, via standard navigation through a set of one or more hierarchical menus available to the user (e.g., starting from a dashboard of the user account). Screens 700 and/or 800 may comprise standard components, such as inputs for selecting filter criteria, navigating to drill-down screens, and/or the like.

Screen 700 comprises one or more statistics based on the persona scores, output by persona model 525, which, in turn, are based on the job level and/or job function output by model 355. These statistic(s) may inform a user as to which contacts to target (e.g., in a marketing campaign). Again, personas are grouped together into levels of persona strength (e.g., strong, moderate, and weak). For each level of persona strength, one or more statistics may be provided. For example, these statistic(s) may comprise the percentage of total contacts at the given level of persona strength, the percentage of opportunities that were created with influence from contacts at the given level of persona strength, the percentage of opportunities that were won with influence from contacts at the given level of persona strength, the conversion rate for creating opportunities when a contact at the given level of persona strength was involved, the conversion rate for winning opportunities when a contact at the given level of persona strength was involved, and/or the like. Screen 700 may also comprise a baseline percentage for the conversion rate for creation of opportunities, and a baseline percentage for the conversion rate for won opportunities.

Screen 800 comprises one or more statistics based on a particular pairing of characteristics (e.g., job level and job function). These statistic(s) may help a user understand which job levels, job functions, and/or other characteristic(s) appear the most in the user's contacts, result in the most conversions, produce the highest conversion rates, and/or the like. It should be understood that screen 800 corresponds to one cell 616 in persona map 610. For example, screen 800 may be displayed when a user selects a cell 616 from persona map 610 and/or in response to one or more other navigation operations. In the illustrated example, the job level is the “human resources” class, and the job function is the “c-level” class. The statistic(s) may comprise, for each characteristic (e.g., the job level and the job function), the class of the characteristic output by model 355, the total count of contacts with the characteristic in the user's contacts, the total number of conversions influenced by contacts with the characteristic, the conversion rate of opportunities influenced by contacts with the characteristic, a factor of increase or “lift” from the baseline conversion rate provided by inclusion of contacts with the characteristic (e.g., the inclusion of a contact with a job function of human resources improved conversion rates by a factor of 1.58 relative to the baseline conversion rate, and the inclusion of a contact with a job level of c-level improved conversion rates by a factor of 1.53 relative to the baseline conversion rate), the percentage of the user's contacts with the characteristic, a percentage of conversions that included a contact with the characteristic, and/or the like.

Another example of a downstream function in which scored personas may be used is contact recommendations. For example, this downstream function may comprise the contact recommendation engine and/or people recommendation engine, described in the '933 publication. In both cases, the engine produces a list of recommended contacts to the user. The recommended contacts represent existing or potential customers, which are recommended for engagement. The contacts to be included in the list of recommended contacts may be selected based on their persona scores, which may be determined as described elsewhere herein. It should be understood that contacts with higher persona scores may be recommended more highly than contacts with lower persona scores, the list of recommended contacts may comprise or consist of a predefined number of contacts with the highest persona scores, and/or contacts with low persona scores (e.g., below a predefined threshold) may be omitted from the list of recommended contacts.

In some cases, a recommended contact in the list of recommended contacts may already be known to the user (e.g., already in the user's CRM system). In this case, the recommendation may be to reach out to that known contact. For example, the list of recommended contacts may be displayed in a screen of the graphical user interface, such that a user can select an input associated with each known contact in the list to initiate a communication (e.g., targeted advertisement, email message, telephone message, etc.) with the selected contact.

In other cases, a recommended contact in the list of recommended contacts may not already be known to the user (e.g., not already in the user's CRM system). For example, the contact may have been derived from a third-party data source used by platform 110 or by server application 112 itself. In this case, the recommendation is to acquire that contact, in order to be able to reach out to that contact. For example, the list of recommended contacts may comprise an input, associated with each unknown contact in the list. Selection of that input may initiate a transaction to purchase that contact (e.g., via a pre-established or other payment method). Prior to purchasing the contact, the contact may remain masked, with only limited information being displayed, such as the contact's job level and/or job function, but no contact information. When the user purchases that contact, the contact may be unmasked and/or added to the user's CRM system.

The above examples represent only a few, non-limiting examples of the downstream functions in which the characteristics (e.g., job levels and/or job functions), derived by model 355, may be used. It should be understood that model 355 may be used for any downstream function that would benefit from an understanding of job titles. As other examples of downstream functions, one or more analytics could be applied to the job levels and/or functions, and/or the job levels and/or job functions in the personas may be tuned for different buying stages in a customer's lifecycle, different market segments, different email campaigns, and/or any other targeted needs.

In an embodiment, the job level and job function of personas, representing the user's contacts in master people database 535, may be integrated with other functions. For example, the job level and job function may be integrated with email data for the user's contacts. In particular, when a user is drafting an email message to a particular contact, the job level and job function may be provided to the user to inform the content, tone, strategy, length, and/or other attribute of the email message.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

As used herein, the terms “comprising,” “comprise,” and “comprises” are open-ended. For instance, “A comprises B” means that A may include either: (i) only B; or (ii) B in combination with one or a plurality, and potentially any number, of other components. In contrast, the terms “consisting of,” “consist of,” and “consists of” are closed-ended. For instance, “A consists of B” means that A only includes B with no other component in the same context.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method comprising using at least one hardware processor to, for each of one or more persons:
receive a job title associated with the person;
apply a machine-learning classification model to the job title to classify one or more characteristics of the job title, wherein the one or more characteristics comprise one or both of a job level or a job function;
generate a persona comprising one or more attributes of the person, wherein the one or more attributes include the one or more characteristics; and
apply a persona model to the one or more attributes to predict a persona score for the persona, wherein the persona score indicates a relative importance of the person to sales opportunities.

2. The method of claim 1, wherein the machine-learning classification model is an artificial neural network.

3. The method of claim 2, wherein the artificial neural network is a deep-learning neural network.

4. The method of claim 3, wherein the deep-learning neural network is a Recurrent Neural Network (RNN) with long short term memory (LSTM).

5. The method of claim 2, wherein applying the machine-learning classification model to the job title comprises embedding each word in the job title into an N-dimensional vector space.

6. The method of claim 1, further comprising, before applying the machine-learning classification model to the job title, standardizing the job title.

7. The method of claim 6, wherein standardizing the job title comprises expanding contractions and abbreviations.

8. The method of claim 1, further comprising, prior to applying the machine-learning classification model, training the machine-learning classification model using a training dataset in supervised learning, wherein the training dataset comprises job titles labeled with ground-truth classes.

9. The method of claim 1, wherein the one or more characteristics comprise the job level.

10. The method of claim 1, wherein the one or more characteristics comprise the job function.

11. The method of claim 1, wherein the one or more characteristics are a plurality of characteristics, including both the job level and the job function.

12. The method of claim 11, wherein the machine-learning classification model comprises a first machine-learning classification model that classifies the job level from the job title, and a second machine-learning classification model that classifies the job function from the job title.

13. The method of claim 1, further comprising storing the persona, in association with the persona score, in a master people database.

14. The method of claim 13, wherein the one or more characteristics are a plurality of characteristics, including both the job level and the job function, and wherein the method further comprises generating a persona map, based on personas in the master people database, wherein the persona map comprises a first dimension representing a plurality of different job levels, and a second dimension representing a plurality of different job functions.

15. The method of claim 14, wherein the persona map comprises a two-dimensional grid with a plurality of cells, wherein each of the plurality of cells represents a pairing of a job level in the first dimension with a job function in the second dimension.

16. The method of claim 15, wherein each of the plurality of cells indicates a number of personas, having the pairing of job level and job function represented by the cell, in each of one or more categories.

17. The method of claim 15, wherein each of the plurality of cells has a color in accordance with a color coding scheme, wherein the color coding scheme assigns a color within a color spectrum to each of the plurality of cells based on the persona scores associated with personas having the pairing of job level and job function represented by that cell.

18. The method of claim 1, wherein the one or more persons are a plurality of persons, and wherein the method further comprises using the at least one hardware processor to provide the personas, generated for the plurality of persons, to a recommendation engine that generates a list of recommended contacts based on the persona scores of the personas.

19. A system comprising:
at least one hardware processor; and
software that is configured to, when executed by the at least one hardware processor,
receive a job title associated with the person,
apply a machine-learning classification model to the job title to classify one or more characteristics of the job title, wherein the one or more characteristics comprise one or both of a job level or a job function,
generate a persona comprising one or more attributes of the person, wherein the one or more attributes include the one or more characteristics, and
apply a persona model to the one or more attributes to predict a persona score for the persona, wherein the persona score indicates a relative importance of the person to sales opportunities.

20. A non-transitory computer-readable medium having instructions stored therein, wherein the instructions, when executed by a processor, cause the processor to:
receive a job title associated with the person;
apply a machine-learning classification model to the job title to classify one or more characteristics of the job title, wherein the one or more characteristics comprise one or both of a job level or a job function;
generate a persona comprising one or more attributes of the person, wherein the one or more attributes include the one or more characteristics; and
apply a persona model to the one or more attributes to predict a persona score for the persona, wherein the persona score indicates a relative importance of the person to sales opportunities.
